(19) United States
(12) Patent Application Publication
(10) Pub. No.: US 2006/0178919 A1
(43) Pub. Date: Aug. 10, 2006

(54) Method, framework and system of position or job sharing between individuals for vertical organization replication and operation duplication

(76) Inventor: Ronald F. Warncke, East Lansing, MI (US)

Correspondence Address: RONALD F. WARNCKE, 16703 BROADVIEW DRIVE, EAST LANSING, MI, 48823, US

(21) Appl. No.: 10/832,145

(22) Filed: Apr. 26, 2004

(51) Int. Cl. G06F 9/46

(52) U.S. Cl. 705/8

(57) ABSTRACT

This invention is a concept, method, framework and system of position or job sharing between individuals for the purpose of replicating an existing vertical organization or a defined vertical group within an existing vertical organization to duplicate the performance or execution of the existing vertical organization or defined vertical group's operations by one or more replicated vertical organizations or replicated defined vertical groups rotating with one another in scheduled time phases during a defined time period.

### CROSS-REFERENCE TO RELATED APPLICATIONS

Research revealed no related applications to this Invention.

### REFERENCE TO ILLUSTRATIONS

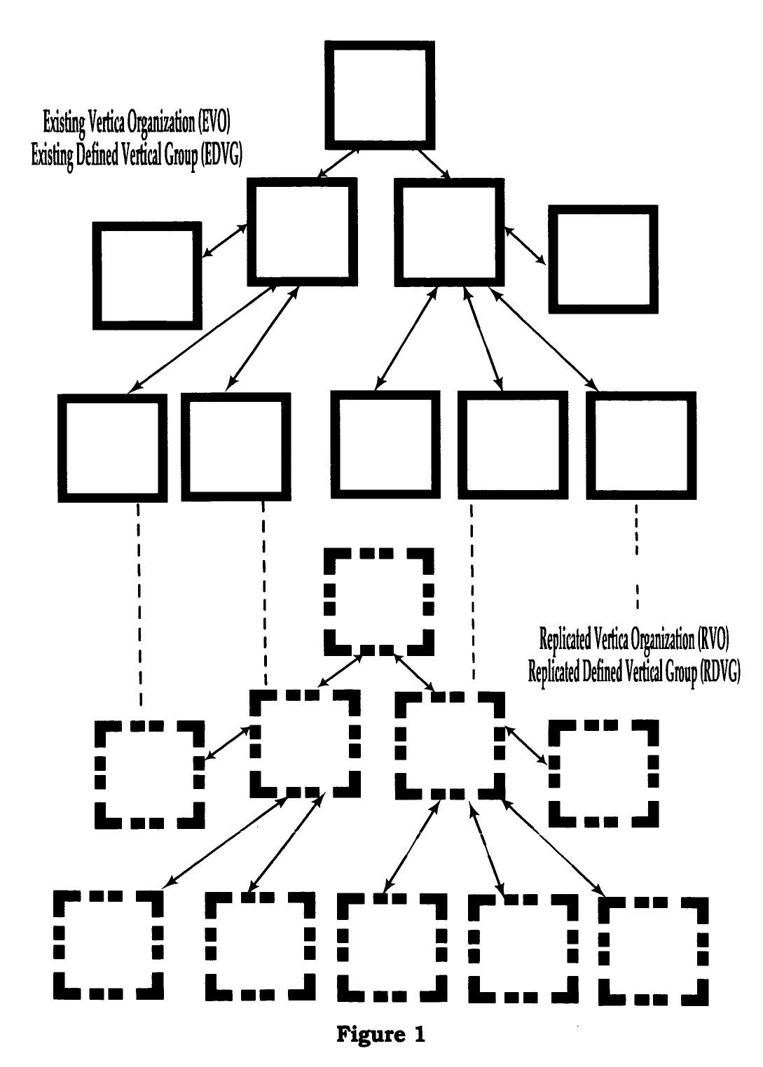

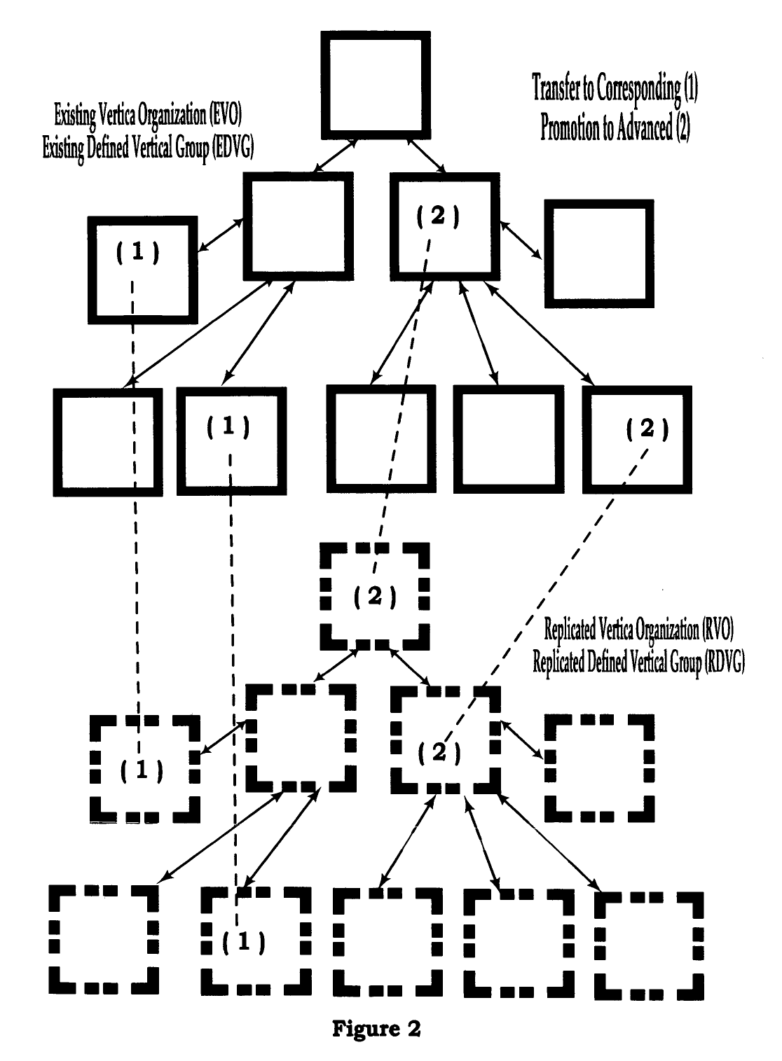

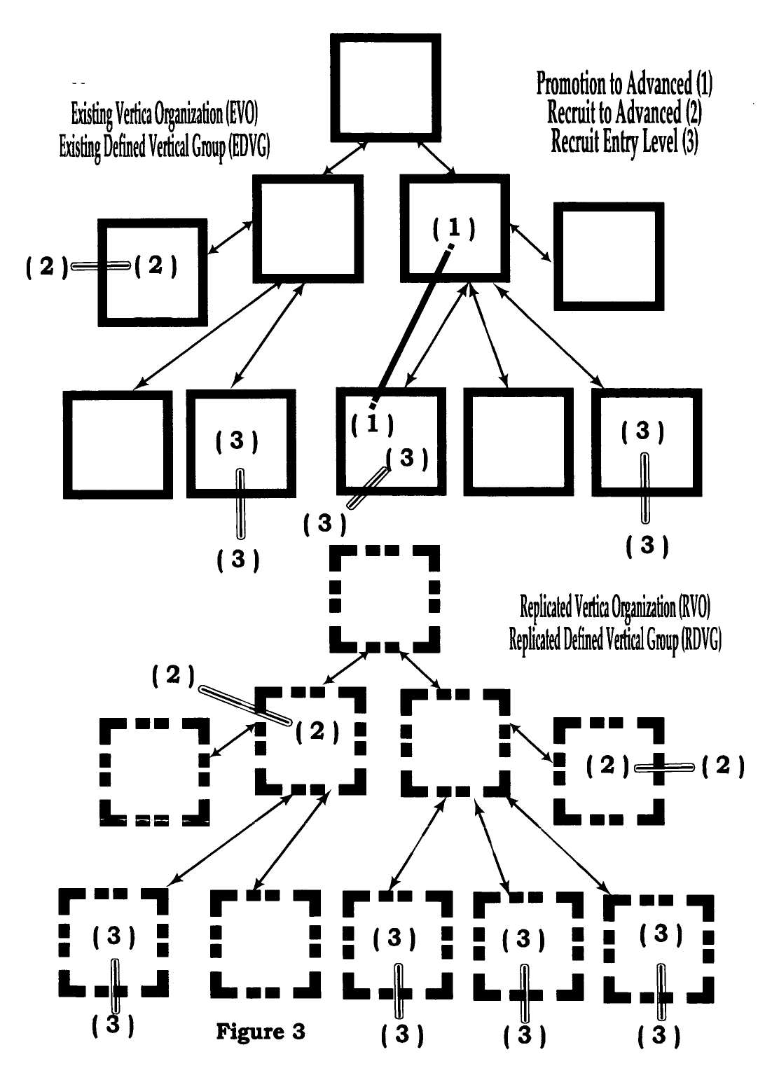

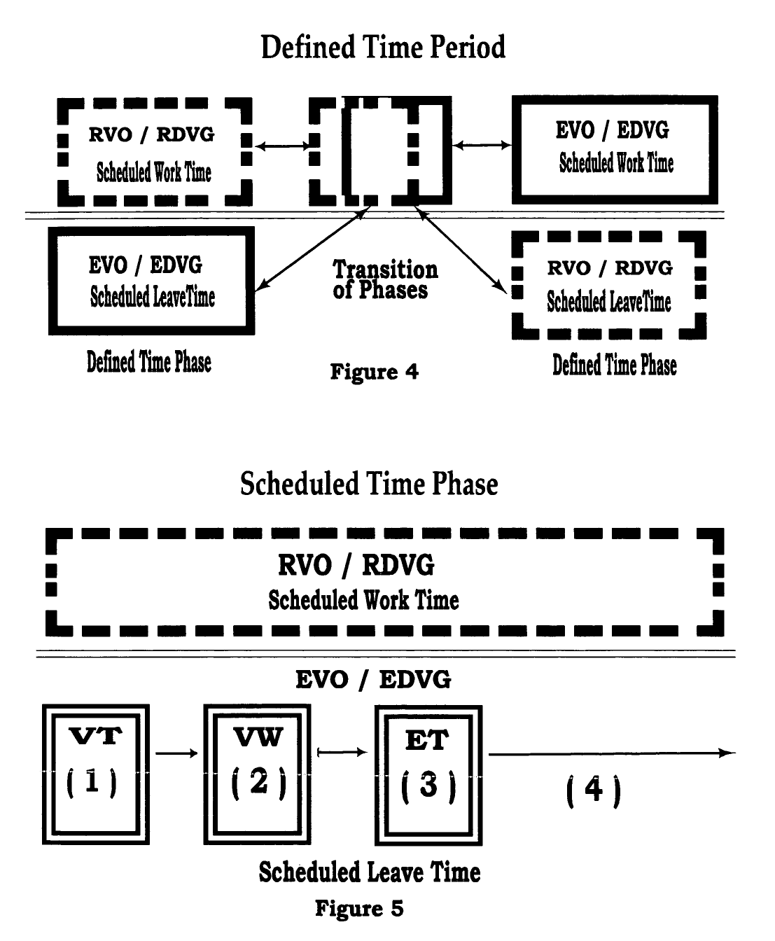

The description of this document follows the illustration of FIG. 1. This illustration represents a sample organizational chart for an Existing Vertical Organization (EVO) or Existing Defined Vertical Group (EDVG) with the vertical representation of executives in charge of group managers, their support staff, and the group managers with positions or jobs under their supervision. The dashed lines demonstrates the organization chart being replicated to create a Replicated Vertical Organization (RVO) or Replicated Defined Vertical Group (RDVG) organizational chart. FIG. 2 illustrates the two organizational charts with individuals being transferred from the EVO or EDVG either directly into a corresponding position or job (1) or being promoted into an advanced position or job (2) in the RVO or EDVG. FIG. 3 illustrates a promotion into an advanced position or job (1) in the EVO or EDVG to fill a vacancy left by a transfer to the RVO or RDVG. FIG. 3 also represents openings in both the EVO or EDVG and the RVO and RDVG being filled by qualified recruits from outside the organization for advanced level positions (2) or entry level positions (3). FIG. 4 illustrates the time line for a Defined Time Period (DTP) and the rotation of the Scheduled Time Phases (STP) for the Scheduled Work Time (SWT) for the RVO or RDVG and at the same time the EVO or EDVG is on a scheduled leave of absence during their Scheduled Leave Time (SLT) for the purpose of the Organization's continuous operation over the DTP. The figure also illustrates the Transition of Phases of the EVO or EDVG from Scheduled Leave Time to Scheduled Work Time and the RVO or RDVG making the transition to Scheduled Leave Time. FIG. 5 illustrates a time line for proposed requirements during the Scheduled Leave Time including: (1) vacation time (VT); (2) volunteer work (VW); (3) education time (ET) for job improvement or general purpose; (4) the remaining time being available for discretional use.

### PURPOSE AND BACKGROUND OF THE INVENTION

The purpose of this invention is to offer one solution for the American workforce's current job creation crisis. The solution the Invention offers lies in the creation of a broad based program to encourage public and private organizations and businesses to replicate either all or defined portions of the organization or business so as to make it possible for two or more individuals to share in performing each one of the single positions or jobs, and then rotating these individuals collectively within the defined vertical organizations or groups, to execute the duties and requirements of the position or job on a continuous daily basis to fulfill the purpose or mission of the organization or business. While one group is working the other group is on leave enjoying a well earned vacation, doing volunteer work, expanding their education and finding new ways to earn income or simply enjoying life more. This solution also offers the opportunity for unemployed individuals to reenter the workforce. It has been estimated that only about one third of the 2003 college graduates were able to find suitable career entry level positions or jobs. This invention would expand the entry level opportunities. Finally, it offers many qualified individuals a tremendous opportunity for career advancement instead of remaining mired in their current positions or jobs because there are no openings for advancement.

The background for this invention is based upon the current state of the American workforce. Since 2000 over three million jobs have been lost to overseas employment markets because of lower labor costs. In addition, a recent study estimates that up to fourteen million jobs in many sectors of our economy are in danger of being lost to overseas markets. Added to this is the increased implementation of automation which has shrunk the number jobs available as new cost effective machines and methods of are introduced to replace workers. The result of these developments is that those individuals still with jobs often have to work longer hours and with less time off in order to fulfil the job's requirements. According to the Economic Policy Institute the average American worker has added nearly 200 hours to a work year in the last 30 years. Paid vacations are also declining, down to 87% of American companies from 95% in 1999. The average American worker receives 10 vacation days a year compared to 30 days in Europe. Finally, a recent study revealed a deep and underlying job discontent when 45% of the American workers surveyed said they would change careers if given the opportunity.

The theory of increased productivity included the expectation that people would have to work less for the same income in a world where the “promise” of a good life would be realized. However, the opposite has often occurred, increased productivity has increased the burdens on those still employed and also created hardship for those displaced by this increased productivity.

It is being said that “The best jobs are staying here.” If that is case, then the “best” single solution for our work force lies in creating a broad based program to encourage organizations, public and private to replicate all or defined portions of the organization such that two or more individuals would share a single position or job and rotating these individuals to execute the duties and requirements of the position or job. Accordingly, they would also share the position or job's compensation.

The benefits of such a solution would be:
The organization could structure each position or job to maximize the time individuals would be required to perform each position or job. Each individual would have a Scheduled Work Time and a Scheduled Leave Time. With the division of labor being between, for example, two individuals they could increase daily performance from eight hours to ten hours. This would increase the utilization of plant and equipment. Lost hours during work time would be made up out of the individual's Scheduled Leave Time thus virtually eliminating the cost of lost job time, because the compensation would be based upon completing all the hours required during the Scheduled Work Time. The Scheduled Leave Time could also include required education to improve job skills and knowledge.

The individuals involved would have the opportunity for a higher quality of life. Surveys have shown that many people would prefer to work longer hours for a designated period of time if they could have more time off later. Under this Invention a more intense scheduled work time would be followed by equal scheduled leave time. This Invention proposes three uses for the Scheduled Leave Time. One portion would be designated as vacation time, a second portion would be designated for unpaid volunteer or public service work and a third portion would be designated for education or training for job improvement. The final portion would be reserved for the individual's discretion.
The American workforce benefits by reducing unemployment and moving towards full employment. Businesses which were severely impacted by September 11^{th} such as tourism, would have the potential to benefit significantly from the vacation provision of this Invention. A nation that averages a mere 10 vacation days a year is over worked and stressed because of it. Under this Invention the American average number of vacation days would increase dramatically.
Organizations relying on volunteers would also benefit significantly. While America is the richest nation on the planet, our per capita giving is the least generous. American's are generous, however finding a way to give more generously is difficult in our over worked society. This Invention's provision for volunteer work would allow us to be more generous and would have a long term impact on improving our image and standing for generosity in the world community.
Finally, Sep. 11^{th} 2001 has had a tremendous impact on higher education. Once one America's best exports, the loss of high numbers of foreign nationals coming here for education, particularly from Middle Eastern countries, has negatively impacted higher education. The education provision of this Invention would result in a higher use of established higher education facilities and faculty with new programs tailored toward meeting the educational needs of participating organizations and individuals who would have more time to pursue educational interests.

Example: ABC Inc.—The corporation's executives form a plan to create ABC's first Replicated Vertical Organization by beginning with a Replicated Defined Vertical Group. They contract with W&S Consultants to formulate a plan. W&S begins by producing a “map” of ABC's physical location of all the employees, managers, staff and executive's workplaces. Using the “map” they draw up an organizational chart (OC) showing each individual's position or job on the OC. Each position or job is then evaluated and described looking for overlapping assignments and assignments that can be combined with another assignment on the OC. ABC is a 40 hour a week business. Hourly employees receive time and half for the additional hours they work. ABC decides to establish the Defined Time Period as one year with two Scheduled Time Phases of six months each. They also decide to convert to a 50 hour workweek during the Scheduled Work Time. The evaluation of the positions or jobs reveals a way to reduce overlapping assignments and the combining of assignments to reduce the number of positions or jobs by 20% within the manager, employee and staff assignments on a 50 hour workweek. Using this data W&S recommends an OC for the first RDVG. The new OC for the RDVG is posted and volunteers are sought for just over half the employee and staff positions and jobs from the Existing Defined Vertical Group to transfer to the RDVG. At this time promotions and transfers are made from about half executive and managerial positions in the EDVG to the RDVG to form a “core” Group in both the EDVG and the RDVG. The next step is to recruit experienced and entry level individuals into the RDVG from outside ABC to fill all the remaining positions or jobs in the RDVG. When the RDVG is fully functional and ready to execute all the operations of the EDVG the first STP is initiated and RDVG begins it SWT and the individuals in the remaining EDVG begin their first SLT. During this first STP new experienced and entry level individuals are recruited to fill the vacant positions and jobs in the EDVG and are trained to be ready to take up their assignments in the EDVG when the first STP expires and the EDVG shifts to SWT and the RDVG shifts to SLT in the second and final STP in the first DTP.

### Mathematical Results

Original EDVG=1 CEO−4 Executives and 96 Position or Jobs and 0 to Transfer or Promote
EDVG less 20%=1 CEO−4 Executive & 76 Positions or Jobs and 20 to Transfer or Promote Distribution Results
EDVG=81=1 CEO−4 Executives & 35 Positions or Jobs Filled and 41 New Hires
RDVG=81=1 CEO−4 Executives & 55 Positions or Jobs Filled and 21 New Hires New Employment Opportunities=61
Since the RDVG will be the first Group to initiate first STP's SWT it needs to be the experienced Core Group. The EDVG will have six months to hire and train the New Hires they will need to be fully staffed when the second STP begins.

Compensation for all positions or jobs in both the EDVG and RDVG will be determined from the application of wave analysis to the total compensation of the original EDVG before the 20% job reduction and including overtime pay to create a core compensation plan to be allocated to each position or job in both the EDVG and RDVG. This plan will allocate compensation for seniority and management responsibility to maintain as much as possible the original level of compensation each original individual had in the original EDVG before the 20% position or job reduction. Under this plan no individual will lose a position or job and the equivalent of about 80% of the positions or jobs in the original EDVG will be created to fill out all the positions or jobs in both the new EDVG and the RDVG. Individuals would able to develop other sources of income during the discretional time in their SLT and compensation reduction would be phased under the wave analysis to allow for this opportunity. Using the “map” W&S helped ABC find ways to reduce their facilities and overhead costs. In implementing this Organization Replication plan all cost savings realized were reallocated into the total compensation so that both the EDVG and the RDVG's compensation packages were as high as possible with the goal of keeping the total as close as possible to the original total compensation plus the savings now realized. There are also significant possibilities of government incentives and tax breaks. A fully employed workforce will generate tax revenues and reduce government assistance cost. These are savings that should be allocated back to participating businesses so as to produce the highest compensation possible.

As part of its assignment W&S would develop: vacation opportunities for the VT in the SLT; plans for how volunteer organizations would utilize the expansion of volunteers during the VW in the SLT; plans for education institutions expand course offerings and use their facilities during the ET in the SLT; create temporary employment opportunities for individuals during their discretionary time in the SLT. ABC's SLT will require 30 days VT, 30 days VW and 30 days ET in their employment contract. The remaining 90 days will be for the individual's personal discretion with restrictions against competitive employment.

Organizations seeking to develop organization replication plans will benefit from governmental participation designed to encourage participation. These could include tax incentives and assistance with training. The expansion of this Invention has the potential to transform our society and the world and change we only thought might one day exist.

### BRIEF SUMMARY OF THE INVENTION

This invention relates in general to a concept of “job sharing” occasionally done on a haphazard basis in some organizations. When done, it is usually on a daily basis where one employee works in the morning and another in the afternoon. This invention takes the concept to the next logical step, to implement an organization or defined group within an organization of position or job sharing at all levels of the organization or defined group by establishing a replication of the existing organization or defined group and rotating the existing and replicated organizations or defined groups to duplicate the performance and execution of the operations during defined scheduled time phases of scheduled work time rotating to scheduled leave time during a defined time period.

### DETAILED DESCRIPTION OF THE INVENTION

Description of the Figures:

FIG. 1 illustrates the organization chart of an Existing Vertical Organization or Existing Defined Vertical Group including executive positions, staff positions, middle management positions and employee positions or jobs which are replicated in the illustrated Replicated Vertical Organization or Replicated Defined Vertical Group chart.

FIG. 2 illustrates: (1) the transferring of current individuals in the Existing Vertical Organization (EVO) or Existing Defined Vertical Group (EDVG) to the replicated position in the Replicated Vertical Organization (RVO) or Replicated Defined Vertical Group (RDVG); (2) the promotion of current individuals in the EVO or EDVG to advanced replicated positions in the RVO or RDVG;

FIG. 3 illustrates: (1) the promotion of current individuals in the EVO or EDVG to fill vacant positions created by the transfer of individuals to the RVO or RDVG; (2) the recruitment of individuals from outside the organization to fill vacancies in both the EVO or EDVG and RVO or RDVG; (3) the recruitment of individuals from outside the organization to fill entry level positions in both the EVO or EDVG and RVO or RDVG.

FIG. 4 illustrates a time line of the rotation of defined Scheduled Time Phases (STP) for the Operational Duplication of the (1) Existing Vertical Organization or Existing Defined Vertical Group with a (2) Replicated Vertical Organization or Replicated Defined Vertical Group and the (3) Transition of Phases time period when the Organizations replace one another.

FIG. 5 illustrates an example of a defined Scheduled Time Phase of the Invention's provisions for requirements during an individual's Scheduled Leave Time including: (1) vacation time; (2) volunteer work for a Volunteer or Public Service Organization; (3) education for job improvement or general purpose; (4) the remaining time available for the discretionary use of the individual.

The Basis of the Invention: The Replication of an Existing Vertical Organizations or a Defined Vertical Group within an existing vertical organization through Position or Job Sharing to provide: (1) Increased Productivity and Facility Utilization of an Organization; (2) Improved Morale and Quality of Life for Participating Individuals; (3) Increased Utilization of Vacation and Tourist Industry Services and Facilities; (4) Increased Participation in and the utilization of the facilities and services of Volunteer and Public Service Organizations; (5) Increased Utilization of Higher Education Services and Facilities.

The Invention meets the existing needs of the American workforce to more fully utilize the talents, expertise and skills of individuals being displaced by the transferring of jobs to offshore locations or by Productivity improvements through automation.

The Invention provides a concept, method and framework to replicate an Existing Vertical Organization or Defined Vertical Group within an existing vertical organization in order to rotate with a Replicated Vertical Organization or Replicated Defined Vertical Group to perform the Duplicated Operations of the Existing Vertical Organization or Existing Defined Vertical Group during Scheduled Time Phases within a Defined Time Period.

For the purpose of the Invention the Replicated Vertical Organization or Replicated Defined Vertical Group includes all the same positions or jobs of the Existing Vertical Organization or Existing Defined Vertical Group with all these positions or jobs being shared and performed by as many individuals as there are Replicated Vertical Organizations or Replicated Defined Vertical Groups (i.e. if only one RVO or RDVG there would be two individuals sharing the performance of the operation of each position or job).

For the purpose of the Invention an Existing Vertical Organization or Existing Defined Vertical Group's Organizational Chart of executives, managers, staff, position or jobs is the basis of the replication of the Organizational Chart of all the executive, managerial, staff, jobs and positions creating a replicated Organizational Chart for a Replicated Vertical Organization or Replicated Defined Vertical Group.

For the purpose of the Invention the moving or promotion of some existing qualified individuals from the executive, managerial, staff, positions or jobs in the Existing Vertical Organization or Existing Defined Vertical Group into the Replicated Vertical Organization or Replicated Defined Vertical Group will form the core basis for creating the ability of the Replicated Vertical Organization or Replicated Defined Vertical Group to duplicate and perform all the operations necessary to fulfill the Organization's mission.

For the purpose of the Invention the remaining vacant positions in the Existing Vertical Organization or Existing Defined Vertical Group shall be filled by promoting existing qualified individuals or recruiting qualified individuals from outside the Organization at the entry level or advanced levels in both the Existing Vertical Organization or Existing Defined Vertical Group or the Replicated Vertical Organization or Replicated Defined Vertical Group until both Organizations are fully staffed to execute and perform all the duties and operations of each position or job. At the point that a fully qualified Replicated Vertical Organization or Replicated Defined Vertical Group is installed, the Existing Vertical Organization or Existing Defined Vertical Group would be placed on Scheduled Leave Time to initiate the first Scheduled Time Phase in the defined rotation of Scheduled Time Phases within a Defined Time Period. During such Scheduled Time Phase the Replicated Vertical Organization or Replicated Defined Vertical Group shall initiate a Scheduled Work Time to perform all the duties and operations of the Organization until such time as the Scheduled Time Phase has expired. At which time either the Existing Vertical Organization or Defined Group or another Replicated Vertical Organization or Replicated Defined Vertical Group shall initiate the next Phase in the Defined Rotation of Phases. At which time the Replicated Vertical Organization or Replicated Defined Vertical Group shall be placed on Scheduled Leave Time until the next Scheduled Time Phase in the rotation of Scheduled Time Phases shall reoccur to resume the duties and performance of the Organization's operations.

For the purpose of the Invention a Scheduled Leave Time shall require an individual's participation in: defined vacation time; defined volunteer work time for a Volunteer or Public Service Organization; defined education time for the taking of educational courses for job improvement or general interest; and with the remaining defined time available for the participant's discretionary use.

For the purpose of the Invention the focus would be on Civilian Organizations with a defined system of Compensation including but not requiring benefits programs consisting of medical coverage, retirement plan, and/or other plans to enhance compensation to individuals participating in the Organization's operation. Payment of Compensation would be spread over the Defined Time Period.

### SUMMARY OF THE INVENTION

The American workforce is plagued by the ongoing departure of jobs overseas. These departures have created hardships for the employees who's jobs were lost by this exodus. Automation resulting in improved productivity has also eliminated many jobs. This same productivity was thought to be the means by which Americans would have an improved quality of life by giving them more time to enjoy life with more freedom from the daily grind of work that was the fate of our forefathers. Instead, increased productivity has reduced jobs and in many instances left those still employed having to work harder and for longer hours. The result has been a lower quality of life and precious little time outside of work to enjoy it. This is exemplified by the fact that Americans average about 10 vacation days a year compared to 30 days in many other advanced countries. In all productivity has not lived up to its promises.

The purpose of this Invention to provide a plan and system to create position or job sharing by replicating each position or job within an Existing Vertical Organization or Existing Defined Vertical Group into two or more Replicated Vertical Organizations or Replicated Defined Vertical Groups to execute and perform the operations of the organization. When one Replicated Vertical Organization or Replicated Defined Vertical Group is working the Existing Vertical Organization or Existing Defined Vertical Group would be on Scheduled Leave Time or vice versa. However, under this Invention the Scheduled Leave Time would require the performance of three activities: a specified vacation time period; a specified volunteer work time period for the benefit of a charitable or public service organization; a specified education time period for training or education to improve job skills or for general interest. Once these requirements are met the remaining time could be devoted to temporary unrelated employment for additional income, or may simply be used to enjoy life.

The long term benefits for Organizations that participate in the Invention would be:
(1) increased productivity from employees during required work schedules;
(2) virtually no loss of productive hours since time missed would be made up during an individual's Scheduled Leave Time as a requirement of their employment;
(3) a fuller utilization of resources and facilities;
(4) higher employee morale as a result of an improved quality of life;
(5) Intra-Organization competition may result in improved operational performance and overall profitability for the organization;

The long term benefits from the Invention for Americans would be increased general prosperity and improved morale from the optimization of its work force towards full employment, the expansion of volunteers to better serve such organizations to fulfill their missions to society, and a better educated work force both for job improvement and the expansion of the knowledge of individuals resulting in happier and more satisfied citizens.

I claim:

1. A concept, method, framework and system of position or job sharing between individuals for the purpose of establishing and implementing the replication of an Existing Vertical Organization or one or more Existing Defined Vertical Groups within an existing vertical organization into one or more Replicated Vertical Organizations or Replicated Defined Vertical Groups to duplicate all the operations of the Existing Vertical Organization or Existing Defined Vertical Group whereby the Replicated Vertical Organization or Replicated Defined Vertical Group shall assume, duplicate, perform and execute all the operational duties, processes, functions, roles, assignments and tasks of the Existing Vertical Organization or Existing Defined Vertical Group during the rotation of Scheduled Time Phases with the Existing Vertical Organization or Existing Defined Vertical Group over a Defined Time Period:
By creating one or more Replicated Vertical Organizations or Replicating Defined Vertical Groups through position or job sharing between two or more individuals for each executive, managerial, staff, position or job of an Existing Vertical Organization or Existing Defined Vertical Group that shall assume, duplicate, perform and execute all the operational duties, processes, functions, roles, assignments and tasks from the Existing Vertical Organization or Existing Defined Vertical Group's executives, managers, staff, positions and jobs;
During which time the Existing Vertical Organization or Existing Defined Vertical Group shall be placed on Scheduled Leave Time to return by rotation at the expiration of a Scheduled Time Phase in a Defined Time Period to resume the duplication, performance and execution of the operational duties, processes, functions, roles, assignments and tasks from a Replicated Vertical Organization or Replicated Defined Vertical Group which shall be rotated to a Scheduled Leave Time to expire at their next Scheduled Time Phase in the Defined Time Period that completes the rotation of all Scheduled Time Phases during the Defined Time Period;

2. A framework and method for implementing the concept, method and system defined in claim 1, said framework and method consisting of:
replicating each position or job in an Existing Vertical Organization or Existing Defined Vertical Group in a Replicated Vertical Organization or Replicated Defined Vertical Group and filling it with a qualified individual with the necessary experience and training to be:
moved from and to the same replicated position or job;
promoted to a higher level in an existing or to the replicated position or job;
to start at the entry level in an existing or replicated position or job; in order to assume, duplicate, execute and perform the operational duties, processes, functions, roles, assignments and tasks of the position or job, for the purpose of either filling a vacancy or of relieving the individual remaining in the position or job in the Existing Vertical Organization or Existing Defined Vertical Group from the obligation of executing and performing the duties, processes, functions, roles, assignments and tasks during the individual's Scheduled Leave Time and until such time as the Scheduled Time Phase or Phases in the Defined Time Period has/have expired and the Existing Vertical Organization or Existing Defined Vertical Group returns to resume the execution and performance of the operational duties, processes, functions, roles, assignments and tasks from the individual in the same position or job in a Replicated Vertical Organization or Replicated Defined Vertical Group;
initiating an individual's Scheduled Leave Time until such time as the Scheduled Time Phase or Phases in the Defined Time Period has/have expired the individual may or shall be obligated to:
take a vacation for a minimum defined period of time during the phase, take a volunteer job, position, assignment or task in or for the benefit of a defined charitable or public service organization for a minimum defined period of time during the phase,
take a course or courses of training, education, or other forms of instruction as maybe specified or required for a minimum defined period of time during the phase,
have an optional temporary job or position of employment, not in conflict with the job or position from which the individual is on leave, for the remaining period of time during the phase.
a Defined Time Period shall be the time during which each Scheduled Time Phase in the rotation cycle is performed once by each Vertical Organization or Defined Vertical Group until the Vertical Organization or Defined Vertical Group that initiated the rotation of the Scheduled Time Phases returns to resume the execution and performance of the operational duties, processes, functions, roles, assignments and tasks of the Vertical Organization or Defined Vertical Group. The term of participation for all individuals in each Vertical Organization of Defined Vertical Group shall be for the entire Defined Time Period, compensation being paid periodically during the entire Defined Time Period. The Organization may at its option require each participating individual to execute an employment contract for one or more Defined Time Periods.

3. A system of claims 1 and 2 embedded in a development environment that allows for the functional operation and maintenance of the Vertical Organizations or Defined Vertical Groups including, but not limited to enhancement, change management, versioning of Vertical Organizations or Defined Vertical Groups, transition of Vertical Organizations or Defined Vertical Groups and coexistence between Vertical Organizations or Defined Vertical Groups.
